(19) United States
(12) Patent Application Publication
(10) Pub. No.: US 2020/0176840 A1
(43) Pub. Date: Jun. 4, 2020

(54) ATP-DEPENDENT GENERATOR/ACCUMULATOR BASED ON ACTIVE MEMBRANES

(71) Applicants: Paolo Sinopoli, Catanzaro (IT); Roberto Pugliese, Catanzaro (IT); Daniele Cipriani, Aranova-Fiumicino (IT)

(72) Inventors: Paolo Sinopoli, Catanzaro (IT); Roberto Pugliese, Catanzaro (IT); Daniele Cipriani, Aranova-Fiumicino (IT)

(21) Appl. No.: 16/610,696

(22) PCT Filed: May 5, 2017
(86) PCT No.: PCT/IT2017/000095

§ 371 Date: Nov. 4, 2019

(51) Int. Cl. H01M 14/00; H01M 8/16

(52) U.S. Cl. CPC H01M 14/00; H01M 8/16

(57) ABSTRACT

ATP-dependent generator/accumulator (based on active membranes) ATP-dependent Generator/Accumulator technology springs from the idea of utilizing differences in potential coming from work going on at the molecular level (generated by proteins of the cell membrane) for the production of electric energy. Cyclic polarization/depolarization is used, coming from a series of membranes, (besides the support of ulterior membranes which have been genetically engineered to carry out functions different from those carried out by the principal membrane). An extremely versatile system is therefore set up which can function both as an accumulator and a generator. It can function as an accumulator because it stores a determined quantity of energy in the form of ATP, and as a generator because it transforms potential energy (the bond energy of the ATP molecule) into electric energy. This new technology, therefore, allows the realization of accumulators that can virtually beat every record of normal recharging times up to 100% capacity. This is carried out by substituting the exhausted ADP-containing solvent which accumulates in the designated tank with a fresh solvent containing ATP; this would allow the realization of accumulators that can be recharged is a very short time, and render them completely independent from the electric grid. As a generator, it produces no toxic or polluting substances, and even the ATP-rich solvent it uses and the ADP-rich by-product it produces are both completely biodegradable. The very technology of this system is indicated where electrical devices need to be miniaturized (and therefore also their accumulators) or where it is necessary that the accumulator assumes a particular form which would otherwise render it impossible to realize. This technology carries no physical or ecological risk in its realization, use or disposal.

### TECHNICAL FIELD

Accumulators are batteries which can be completely recharged from an adequate electrical energy source for a determined period of time. These accumulators depend on the domestic or public energy grid, or on generators, most of which use internal combustion motors to generate electricity.

### BACKGROUND ART

Various types of accumulators exist, having different electrical capacities, chemical compositions, shapes and sizes. The most common types of accumulators include:

A) Lead-acid batteries, the main advantage of which is their low cost. Their limitation is their decreased energy density as compared to other more expensive chemical accumuators;
1) Absorbed glass mats (AGM);
2) Gel batteries;

B) Lithium ion batteries (chemical accumulators). These offer a very high charge density and are not subject to the lazy battery effect;

C) Lithium-polymer ion batteries, which possess a charge density slightly inferior to that of the Lithium-ion battery, but can easily be adapted to particular shapes;

D) Sodium-sulphur batteries;

E) Nickel-iron batteries;

F) Nickel-metal Hydride (NiMH) batteries;

G) Nickel-cadmium (Ni—Cd) batteries, which have been outclassed by Li-ion and NiMH batteries. Ni—Cd batteries are also subject to the lazy battery effect and cadmium is a toxic heavy metal;

H) Sodium/metal chloride batteries;

I) Nickel-zinc batteries;

L) Molten salt batteries;

M) Silver-zinc batteries—these have the highest energy density but the production costs are excessive.

As mentioned, generators have traditionally been based on internal combustion engines, but experimental-phase patents are springing up regarding bio-generators that use live culture cells to produce electric current.

### DISCLOSURE OF INVENTION/BRIEF DESCRIPTION OF DRAWINGS

The technology of the ATP-dependent generator/accumulator is based on the idea of utilizing the differences in potential deriving from the molecular activity generated by the proteins of the cell membrane (implemented both as they are or featuring the possibility to be engineered in order to optimize its functions).

Therefore, the ATP-dependent generator/accumulator starts with the construction of a series of fundamental structures called energy cells, which are contained in a double phospholipidic membrane (bilayer) or equally efficient material (which allows the localization of the energy cells and the carrying out of the molecular activity cited) resembling a cell membrane but perhaps a streamlined version—simpler and equally efficient.

The double phospholipidic membrane that will be used in toto in the model, in fact, contains far fewer trans-membranic proteins when compared to an actual cell, but having a greater surface density. The basic functional proteic structures that our membrane model will contain will be:
1) Voltage-gated sodium channels (which are not all the same; their composition differs in one or more amino acids and they open in response to slightly differing membrane potentials);
2) Voltage-gated potassium channels;
3) ATP-ADP translocases;
4) Sodium-potassium pumps

However, it must be stressed that, based on the characteristics that one aims to attain, the channels that are selected can vary beyond those already cited, i.e. calcium channels (in this case, obviously, the whole system must be adapted with the inclusion of the sodium-calcium pump).

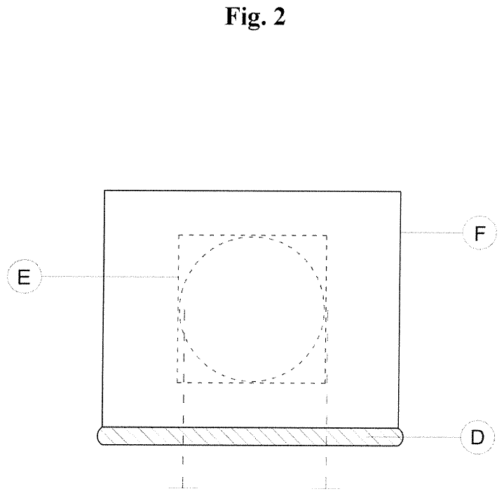

The energy cell of the device is constituted by an internal structure (“core” identified in FIG. 2 with letter E) with membranes on all its surfaces (in which proteic anions may be included) presenting ALL of the active molecules already mentioned (these membranes can include internal or external mechanical support structures made of, for example, Murein; the choice will be based on the desired results).

This internal structure, which we are calling a “core” (the form of which can vary, for example to optimize production or increase stability; this must be considered implicit even though we will continue to use the term “core” for simplicity) is in turn confined to a container presenting only a single active/functional surface constituted of a membrane. The remaining surfaces will all be constituted by inert material (identified in FIG. 2 with letter F).

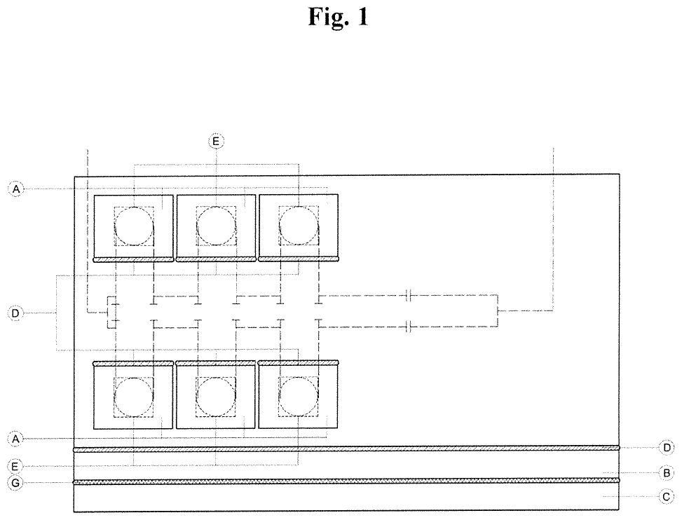

The single active/functional surface of the container will contain just one molecule: the ATP-ADP translocase (in contrast to the membranes of the core containing the multiple molecules identified in FIGS. 1 and 2 with letter D).

In review; the core and container of the device, then, are the basic structure of the energy cell (shown in FIG. 2 as cubes, while is identified in FIG. 1 with letter A).

The core polarizes and depolarizes as do normal living cells. However, differently from living cells which must be activated, the core polarizes cyclically, so the generation of the electrical impulse is regular and rhythmic thanks to the presence of the Funny channels (therefore the solution in the accumulator must contain cyclic adenosine monophosphate [cAMP] to render the action of these channels efficient).

The accumulator will contain a variable number of energy cells (according to the desired characteristics) which will be arranged in series and will constitute the “ranks”. The accumulator will contain many “ranks”.

The ranks will be divided in “blocks” which will be electrically isolated from each other (so that some are “resting” while others are “working”).

The number of blocks present in a generator/accumulator will be influenced by the refractory period of the single energy cells/blocks, besides those necessitated by the additional desired characteristics such as capacity or tension. So the functioning of the entire system will depend on the sodium-potassium pump which will consume ATP and produce ADP; this is why this generator/accumulator is said to be “ATP dependent”.

The ADP produced during the functioning of the generator/accumulator will be accumulated in a specific compartment (waste/supply tank, identified in FIG. 1 with letter C) thanks to the activity carried out by the ATP-ADP translocase present in the various interface membranes of the various compartments.

The exhausted, ADP-rich solvent is then eliminated and replaced with an ATP-rich solvent with extreme ease and safety.

The greatest advantage of this is the use of the ATP solvent and not the electrical grid, when the device is considered an accumulator (of energy in the form of ATP).

The energy cells (cores+containers), as already mentioned, will be positioned inside other containers. These containers will once again have a single active surface or membrane which will again be furnished with a single molecule: the ATP-ADP translocase.

The purpose of this second ATP-ADP translocase-containing membrane is that of furnishing a second ATP-rich micro-environment (the first is furnished by the active membrane that contains the core and comprises the primary energy cell) and to constitute a second system that conveys the ADP towards the waste tank that exclusively contains the exhausted, ADP-rich solvent.

Considering the function of this membrane—which is that of creating precise transfer flows for both the ATP and ADP inside the accumulator—it will be necessary to exercise great precision in directioning the molecule so that it carries the ATP TO the energy cell and carries the ADP FROM the energy cell.

This membrane, in turn, puts the compartment containing the various energy cells in communication with an ulterior compartment called an intermediate chamber (identified in FIG. 1 with letter B).

The intermediate chamber, in turn, presents another single active surface exposed to the successive compartment (which is the waste/refill compartment) with which it will exchange ADP and ATP.

Again the function of this layer is that of conveying the ATP into the intermediate chamber and moving the ADP towards to the waste compartment where it will be discarded before being refilled with new solvent upon complete exhaustion (See FIG. 1). The membranes (which have ATP-ADP translocase as the single active molecule, identified in FIG. 1 with letter G) and their relative compartments will form a concentration gradient which will allow the increase of the ATP in the direction of the energy cells and the increase of the ADP in the direction of the waste/refill compartment. The waste/refill compartment can then be emptied of the exhausted solvent having a high concentration of ADP and substituted with a solvent rich in ATP and cAMP (essential for the correct functioning of the Funny channels, besides that of all the other necessary ions.).

The membranes which, up to now, have been described as a single phospholipidic bilayer, could also consist of several stacked phospholipidic bilayers containing the same active molecules (in the sense of quality and type) both to obtain characteristics which optimize functionality and to obtain characteristics which furnish structural durability. The waste/refill compartment can be mechanically isolated so that it does NOT refurnish the cells and chambers in the case that the suspension of the production of electrical energy is desired (on/off function).

The generator to tally changes the concept of both electric generator and accumulators. In fact the ATP-dependent generator/accumulator (based on active membranes) eliminates every physical risk be-sides problems of disposal of the components and allows maximum environmental sustainability.

A further advantage is the reduction of the recharging time when the same ATP-dependent generator/accumulator (based on active membranes) is considered an accumulator.

### BEST MODE FOR CARRYING OUT THE INVENTION

The production process can be divided into 4 different non-chronological macro phases. The first phase consists of the production of the phosopholipidic bilayer.

Phospholipids are a class of lipids that are a primary constituent of cell membranes and contain phosphate. The molecules belonging to this class of organic compound have a structure consisting of a hydrophilic, polar “head” (which is soluble in water and insoluble in apolar solvents) and two hydrophobic, apolar, fatty acid “tails” (which are insoluble in water and soluble in apolar solvents), making these molecules amphipathic. Besides the amphipathic characteristics of these molecules, it is important to underline the fact that every specific phospholipid molecule has a critical temperature or “melting point” at which transformation from a solid to a liquid phase comes about.

The energy cell model that we are realizing does not need the fluidity that is physiologically present in a cell membrane, so molecules that favor a fluid mosaic model will not be included. However, this type of selection of molecules can vary, based on the characteristics one wants to achieve.

In our generator/accumulator, we will also exclude molecules such as cholesterol for the same reason, and will select phospholipidic molecules that favor the liquid crystalline phase identified by Luttazzi as the L beta and L beta′ phase instead. The gel-crystalline phase we want is that in which the hydrocarbon chains are oriented in a parallel manner either perpendicular to or inclined towards the membranes.

In order to realize these bilayers we will prevalently use phosopholipids with fatty acids having 16 or more carbon atoms, as saturated as possible, which will allow transformation to the gel or crystalline state.

To this end, the following techniques or methods could be used (selecting and perfecting one of the two in order to guarantee the maximum active molecular density per phospholipidic surface):
1) vesicular fusion;
2) combination of the Langmuir-Blodgett technique with the vesicular fusion technique.

The selection of the substrate can range among the following:
1) fused silica;
2) borosilicate glass;
3) mica;
4) oxidized silica;
5) a thin titanium dioxide film;
6) Indium tin oxide;
7) gold;
8) silver;
9) platinum.

In any case, the aim is that of obtaining a high-quality membrane (that is, few, if any defects and high lipidic mobility) with a hydrophylic, smooth, clean surface.

The second macro phase is that of constituting the rest of the described membranes following the same steps as those described in the first macro phase, except that for these membranes, it is fundamental to include the ATP-ADP translocase (which is needed to realize the interface membranes between the various chambers). However, the realization of these membranes could also be achieved through the use of other methodologies besides those already described (such as the use of dip pen nanolithography [DPN]).

The membranes of the I and II macro phases can be stabilized through the implementation of support materials such as Murein, in which case it will be necessary to evaluate the insertion of the ulterior molecules which will make this possible (for example, in the case of the use of Murein; lipoteichoic acids).

The third macro phase is the synthesis of the various active molecules, some of which include;
1) the Funny channels;
2) the voltage-gated sodium channels (which are not all the same—they differ in one or more amino acids and they open at slightly differing membrane potential values);
3) the voltage-gated potassium channels;
4) ATP-ADP translocase;
   sodium-potassium pumps.

The sodium-potassium pumps will be synthesized through the use of Recombinant DNA (rDNA) technology which will have elevated initial costs, but which will be enormously offset once production has begun.

The types of voltage-gated sodium channels to be used will be determined by the desired characteristics of the generator/accumulator.

The fourth macro phase will be to obtain the ATP solvent which allows our system to produce energy. In order to realize this aim, bio-reactors will be used through which our solution will pass (initially a glucose solution). These bio-reactors will contain enzymes of glycolysis (also obtained through Recombinant DNA [rDNA] technology) that will transform the glucose molecules into ATP molecules. This process can be further refined through the use of oxidative phosphorylation which will produce a net yield of many molecules of ATP for each molecule of glucose.

### INDUSTRIAL APPLICABILITY

The fields of implementation of this generator/accumulator vary widely, but can be

principally summed up in the realization of electric vehicles with greatly reduced recharging times (In which case it has the option of acting both as generator and accumulator, or only as a generator combined with a traditional battery).

In addition, the prospects of utilization include devices which require accumulators with dimensions or forms that other technologies do not allow. In particular, this technology allows a notable reduction in dimensions.

1) The technology regarding the ATP-dependent generator/accumulator (based on activated membranes) is intended as follows. Any technology implementing “activated membranes”, (which are membranes rendered active by means of biological molecules) if the finality is that of producing electrical energy through the alternation of polarization-depolarization;

2) Considering point 1, the use of the molecules employed to activate the membranes necessary for the realization of the following systems:
(1) systems based on voltage-gated sodium channels if the finality is that of producing electrical energy;
(2) systems based on voltage-gated potassium channels if the finality is that of producing electrical energy;
(3) systems based on ATP-ADP translocases if the finality is that of producing electrical energy;
(4) systems based on sodium-potassium pumps if the finality is that of producing electrical energy;
(5) systems based on calcium channels if the finality is that of producing electrical energy;
(6) systems based on sodium-calcium pumps if the finality is that of producing electrical energy;
(7) systems based on funny current if the finality is that of producing electrical energy;
(8) systems based on ADP/ATP translocases if the finality is that of producing electrical energy;
these are intended both as a whole and partially that is, the omission or rearrangement of some of the molecules, both based on the described scheme as is or by the modification of said scheme, if the finality is that of producing electrical energy through the alternation of polarization-depolarization;

3) Considering points 1 and 2, the use of the ATP molecule to directly or indirectly produce electrical energy;

4) Considering points 1, 2, and 3, the modification of the protein structures on which the project is based in order to optimize the yield, if finalized to the direct or indirect production of electrical energy.
